(19) United States
(12) Patent Application Publication
(10) Pub. No.: US 2011/0065378 A1
(43) Pub. Date: Mar. 17, 2011

(54) WIRELESS TERMINAL AND COMMUNICATION PROCESS

(75) Inventor: Masahiro Watanabe, Kawasaki (JP)

(73) Assignee: FUJITSU LIMITED, KAWASAKI-SHI (JP)

(21) Appl. No.: 12/883,774

(22) Filed: Sep. 16, 2010

(30) Foreign Application Priority Data
Sep. 17, 2009 (JP) 2009-215128

(51) Int. Cl. H04H 20/71

(52) U.S. Cl. 455/3.01

(57) ABSTRACT

In a wireless terminal which performs wireless communication with other wireless terminals by using a first time interval for data transmission and a second time interval for data reception: a receiver receives from one of the other wireless terminals a request for broadcast communication; and a controller generates broadcast control information and controls the wireless terminal according to the present invention so as to transmit the broadcast control information to the other wireless terminals in the first time interval after the receiver receives the request, where the broadcast control information instructs the one of the other wireless terminals to transmit broadcast data in the second time interval, and instructs the other ones of the wireless terminals to receive the broadcast data in the second time interval.

### CROSS-REFERENCE TO RELATED APPLICATION

This application is based upon and claims the benefits of priority from the prior Japanese Patent Application No. 2009-215128, filed on Sep. 17, 2009, the entire contents of which are incorporated herein by reference.

### FIELD

The embodiments discussed herein relate to a wireless terminal and a communication process.

### BACKGROUND

The mobile communication systems include the independent (private or nonpublic) communication systems as well as the public mobile telephone systems and the Internet communication system. (For example, the communication systems used by police or fire organizations for the purpose of rescue or disaster prevention are independent communication systems.) The independent communication systems include the systems in which wireless communication is performed between a wireless terminal and a base station in a similar manner to the cellular communication, and the systems in which wireless communication is performed between wireless terminals which are located outside the coverage areas of base stations (for example, wireless terminals located in a disaster field).

FIG. 20 illustrates a system configuration of an independent communication system in which wireless communication is performed between wireless terminals and a base station. In FIG. 20, a base station 101 and wireless terminals 111 to 114 are illustrated, where the arrowed solid line indicates uplink transmission, and the arrowed dashed line indicates downlink transmission. As illustrated in FIG. 20, the wireless terminals 111 to 114 are located within the coverage area of the base station 101, and perform communication through the base station 101. For example, in the case where the wireless terminal 112 makes a broadcast call to the wireless terminals 111, 113, and 114, data to be transmitted from the wireless terminal 112 is once transmitted to the base station 101, and is then transmitted to the wireless terminals 111, 113, and 114.

FIG. 21 illustrates a system configuration of an independent communication system in which wireless communication is performed between wireless terminals located outside the coverage areas of base stations. In FIG. 21, wireless terminals 121 and 131 to 133 are illustrated, where the arrowed solid line indicates uplink transmission, and the arrowed dashed line indicates downlink transmission. In the case where the wireless terminals 121 and 131 to 133 are located outside the coverage areas of the base stations, wireless communication between the wireless terminals can be secured by making one of the wireless terminals operate as a master (e.g., perform the operations of the base station 101 in FIG. 20 including scheduling). For example, wireless communication between the wireless terminals 131 to 133 can be secured by making the wireless terminal 121 operate as a master.

For example, the above manner of making one of the wireless terminals operate as a master is used by police or fire organizations in disaster fields. The wireless terminal 121 which is used as the master is mounted, for example, on a command car.

In a known ad hoc network (as disclosed in Japanese Laid-open Patent Publication No. 2008-109286), in order to prevent exhaustion of resources of spreading codes, spreading codes for the respective terminals are managed by a base station to which the respective terminals belong even when communication to another base station is performed.

Unlike the fixedly arranged base station, the master wireless terminal can be mounted on a vehicle or the like. Therefore, efficient battery use is required in the master wireless terminal. Nevertheless, when broadcast transmission is performed, the amount of processing increases, so that power consumption increases.

For example, when the wireless terminal 131 performs broadcast transmission to the wireless terminals 132 and 133 in the configuration of FIG. 21, the wireless terminal 121 once receives data transmitted from the wireless terminal 131, and then broadcasts the received data to the wireless terminals 132 and 133. Therefore, the data transfer through the wireless terminal 121 increases the amount of processing performed by the wireless terminal 121, and the consumption power increases.

### SUMMARY

According to an aspect of the present invention, a wireless terminal which performs wireless communication with other wireless terminals by using a first time interval for data transmission and a second time interval for data reception, comprising: a receiver which receives from one of the other wireless terminals a request for broadcast communication; and a controller which generates broadcast control information and controls the wireless terminal so as to transmit the broadcast control information to the other wireless terminals in the first time interval after the receiver receives the request, where the broadcast control information instructs the one of the other wireless terminals to transmit broadcast data in the second time interval, and instructs the other ones of the other wireless terminals to receive the broadcast data in the second time interval.

The objects and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1A illustrates an example of a configuration of a wireless communication system according to a first embodiment;

FIG. 1B illustrates time intervals of transmission and reception in a wireless frame in the case where wireless communication is performed between a wireless terminal and a master wireless terminal in the wireless communication system according to the first embodiment;

FIG. 2 illustrates an example of a configuration of a wireless communication system according to a second embodiment;

FIG. 3 illustrates time intervals of transmission and reception in a wireless frame in the case where wireless communication is performed between a wireless terminal and a master wireless terminal in the wireless communication system according to the second embodiment;

FIG. 4 illustrates an example of a structure of a wireless subframe in the downlink interval indicated in FIG. 3;

FIG. 5 illustrates time intervals of transmission and reception in a wireless frame in the case where a wireless terminal performs broadcast transmission in the wireless communication system according to the second embodiment;

FIG. 6 illustrates an example of a structure of a wireless subframe in the downlink interval indicated in FIG. 5;

FIG. 7 indicates a flow of processing performed by wireless terminals and a master wireless terminal for broadcast communication according to the second embodiment;

FIG. 8 illustrates timing adjustment in a cellular communication mode according to a third embodiment;

FIG. 9 indicates a sequence of operations performed for timing adjustment in the cellular communication mode according to the third embodiment;

FIG. 10 illustrates timing adjustment in a broadcast communication mode according to the third embodiment;

FIG. 11 indicates a sequence of operations performed for timing adjustment in the broadcast communication mode according to the third embodiment;

FIG. 12 indicates a flow of processing for broadcast communication according to a fourth embodiment;

FIG. 13 illustrates an example of a data structure of a broadcast reception timing table according to the fourth embodiment;

FIG. 14 indicates a flow of processing performed by wireless terminals and a master wireless terminal for broadcast communication according to the fourth embodiment;

FIG. 15 illustrates an example of a data structure of a timing-adjustment interval table according to a fifth embodiment;

FIG. 16 indicates a flow of processing for periodically performing timing adjustment according to the fifth embodiment;

FIG. 17 indicates a flow of processing performed for timing adjustment in the broadcast communication mode according to a sixth embodiment;

FIG. 18 is a block diagram illustrating a construction of a master wireless terminal;

FIG. 19 is a block diagram illustrating a construction of a wireless terminal;

FIG. 20 illustrates an example of a configuration of an independent communication system in which wireless communication is performed between a base station and wireless terminals; and

FIG. 21 illustrates an example of a configuration of an independent communication system in which wireless communication is performed between wireless terminals located out of a coverage area of a base station.

### DESCRIPTION OF EMBODIMENTS

The embodiments will be explained below with reference to the accompanying drawings, wherein like reference numbers refer to like elements throughout.

### 1. First Embodiment

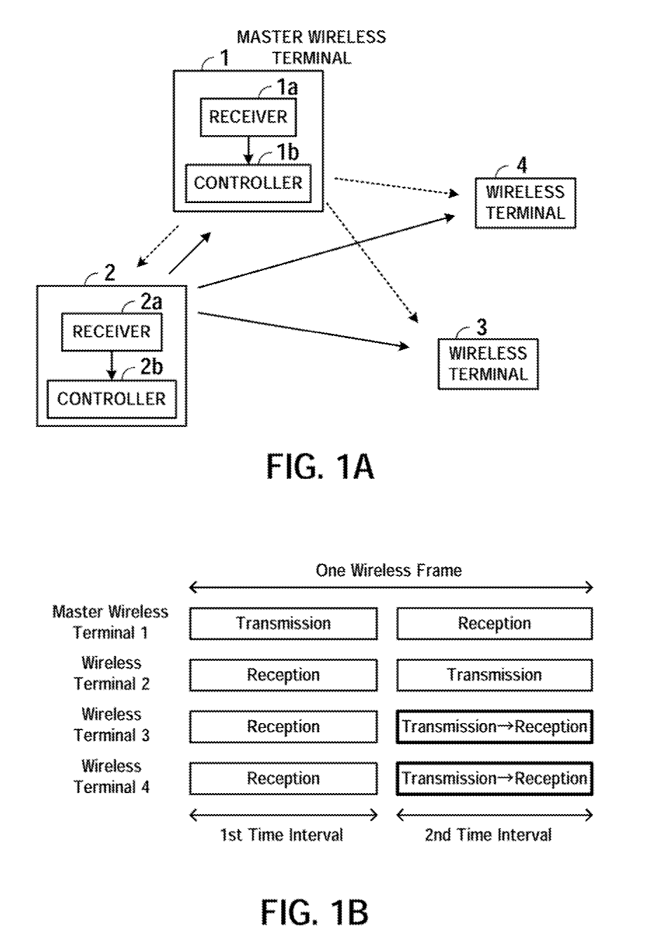

The first embodiment is explained in detail below with reference to FIGS. 1A and 1B. FIG. 1A illustrates an example of a configuration of a wireless communication system according to the first embodiment. In FIG. 1A, a master wireless terminal 1 and wireless terminals 2 to 4 which constitute the wireless communication system according to the first embodiment are illustrated. FIG. 1B illustrates time intervals of transmission and reception in a wireless frame in the case where wireless communication is performed between the wireless terminals 2 to 4 and the master wireless terminal 1 in the wireless communication system according to the first embodiment. (In FIG. 1B, time progresses from the left to the right.) For example, as indicated in FIG. 1B, in the first time interval, the master wireless terminal 1 transmits data, and the wireless terminals 2 to 4 receives the data. In addition, in the second time interval, the wireless terminals 2 to 4 transmit data, and the master wireless terminal 1 receives the data. Further, in the second time interval, the wireless terminals 3 and 4 switch their operation mode from the data transmission to the data reception.

The master wireless terminal 1 comprises a receiver 1a and a controller 1b. Normally, the master wireless terminal 1 performs wireless communication with the wireless terminals 2 to 4 by using the first time interval for data transmission and the second time interval for data reception. The receiver 1a receives from one of the wireless terminals 2 to 4 a request for broadcast communication. When the receiver 1a receives the request for broadcast communication, the controller 1b generates broadcast control information, and controls the master wireless terminal 1 so as to transmit the generated broadcast control information to the wireless terminals 2 to 4 in the first time interval. The broadcast control information instructs the one of the wireless terminals 2 to 4 to transmit the broadcast data in the second time interval, and instructs the other ones of the wireless terminals 2 to 4 to receive the broadcast data in the second time interval.

The wireless terminal 2 comprises a receiver 2a and a controller 2b. The wireless terminal 2 performs wireless communication with the master wireless terminal 1 by using the first time interval for data reception and the second time interval for data transmission. Although not illustrated, each of the wireless terminals 3 and 4 also has a receiver and a controller which are respectively similar to the receiver 2a and the controller 2b in the wireless terminal 2.

The receiver 2a receives the broadcast control information from the master wireless terminal 1 in the first time interval. When the receiver 2a receives the broadcast control information, the controller 2b performs, in the second time interval, broadcast transmission of broadcast data to the other wireless terminals 3 and 4 or reception of broadcast data from one of the other wireless terminals 3 and 4, based on the broadcast control information.

For example, when the wireless terminal 2 transmits to the master wireless terminal 1a request for broadcast communication, the controller 1b in the master wireless terminal 1 generates broadcast control information, and controls the master wireless terminal 1 so as to transmit the generated broadcast control information to the wireless terminals 2 to 4 in the first time interval. The broadcast control information instructs the wireless terminal 2 to transmit broadcast data in the second time interval, and instructs the wireless terminals 3 and 4 to receive the broadcast data in the second time interval.

When the receiver 2a in the wireless terminal 2 receives the broadcast control information in the first time interval, the controller 2b controls the wireless terminal 2 so as to broadcast the broadcast data to the wireless terminals 3 and 4 in the second time interval on the basis of the received broadcast control information as illustrated in FIG. 1B.

When the receiver in each of the wireless terminals 3 and 4 receives the broadcast control information in the first time interval, the controller in the wireless terminal controls the wireless terminal so as to receive the broadcast data in the second time interval on the basis of the received broadcast control information as illustrated in FIG. 1B.

As explained above, when broadcast communication is performed, the wireless terminals 3 and 4 switch their operation mode in the second time interval from the data transmission mode to the data reception mode. Therefore, transmission and reception of broadcast data can be performed between the wireless terminals 2 to 4 without being relayed by the master wireless terminal 1. Thus, the amount of processing performed by the master wireless terminal 1 for realizing the broadcast transmission can be reduced, so that the power consumption in the broadcast transmission can be reduced.

### 2. Second Embodiment

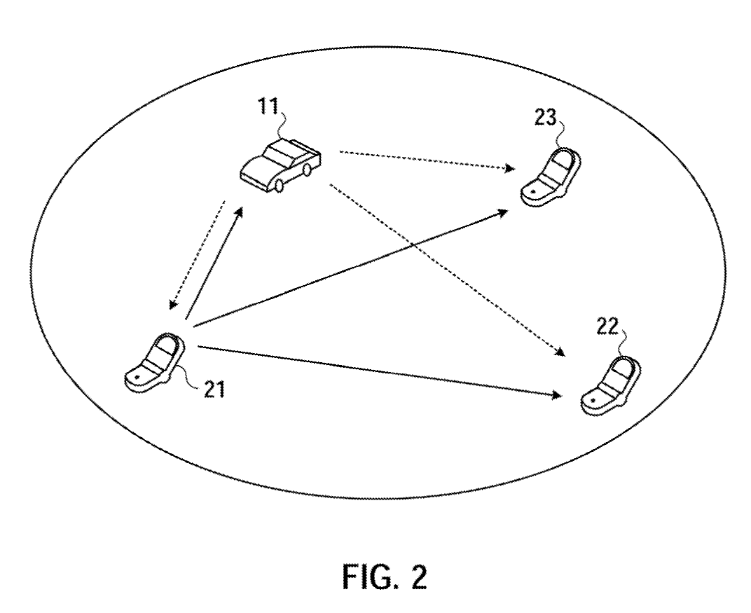

The second embodiment is explained in detail below with reference to FIGS. 2 to 7.

FIG. 2 illustrates an example of a configuration of a wireless communication system according to the second embodiment. In FIG. 2, wireless terminals 11 and 21 to 23 which constitute the wireless communication system according to the second embodiment are illustrated. For example, the wireless terminal 11 may be mounted on a vehicle of a police or fire organization, and the wireless terminals 21 to 23 may be mobile telephones.

The wireless terminals 11 and 21 to 23 perform wireless communication in accordance with Mobile WiMAX. (WiMAX stands for Worldwide Interoperability For Microwave Access.) The wireless terminal 11 can behave as a base station for the wireless terminals 21 to 23, and performs, for example, scheduling of the wireless terminals 21 to 23. (Hereinafter, the wireless terminal 11 may be referred to as the master wireless terminal 11.) The wireless terminals 11 and 21 to 23 are located at such a distance from each other that broadcast communication can be performed between the wireless terminals 11 and 21 to 23. For example, the wireless terminal 21 can perform broadcast transmission to the wireless terminals 11, 22, and 23.

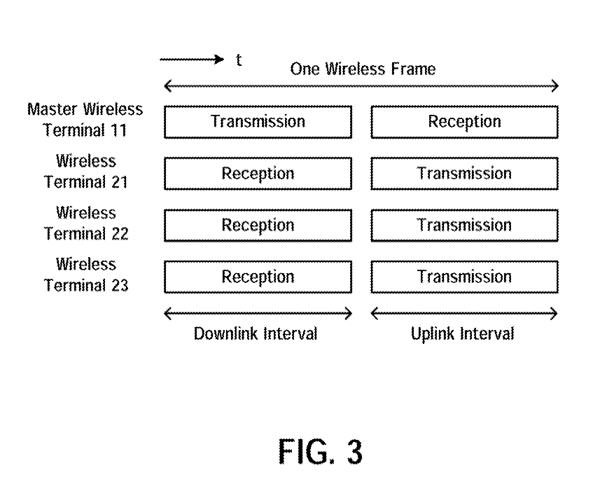

FIG. 3 illustrates time intervals of transmission and reception in a wireless frame in the case where wireless communication is performed between the master wireless terminal 11 and the wireless terminals 21 to 23 in the wireless communication system according to the second embodiment. (In FIG. 3, time progresses from the left to the right.) As illustrated in FIG. 3, each of the wireless terminals 11 and 21 to 23 perform transmission and reception of data in accordance with TDD (Time Division Multiplex). That is, data transmission and data reception are performed in each wireless frame in a time shared manner. Specifically, the time interval of each wireless frame is divided into the downlink interval and the uplink interval. Data is transmitted from the master wireless terminal 11 to the wireless terminals 21 to 23 in the downlink interval, and from the wireless terminals 21 to 23 to the master wireless terminal 11 in the uplink interval.

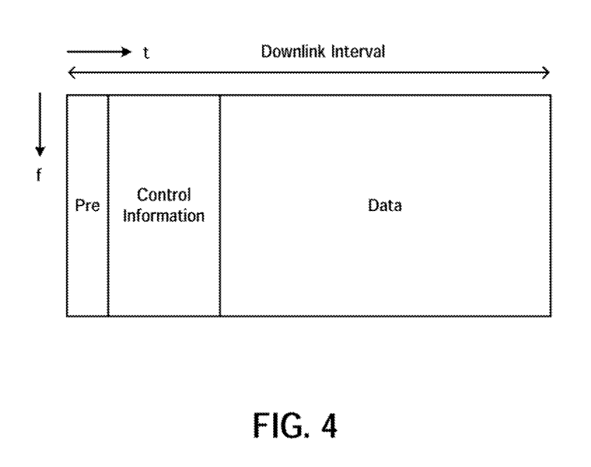

FIG. 4 illustrates an example of a structure of a wireless subframe in the downlink interval indicated in FIG. 3. (In FIG. 4, the abscissa indicates the progression of time, and the ordinate indicates the carrier frequency.) As illustrated in FIG. 4, the wireless subframe in the downlink interval contains the time intervals for the preamble (indicated by “Pre” in FIG. 4), control information, and data.

In the time interval for the preamble, a preamble signal is transmitted from the master wireless terminal 11 to the wireless terminals 21 to 23 (which are subordinate to the master wireless terminal 11), so that the wireless terminals 21 to 23 can receive the preamble signal, and realize synchronization in reception of the wireless subframe in the downlink interval.

In the time interval for the control information, the control information is transmitted from the master wireless terminal 11. For example, the control information includes a DL-MAP (downlink map), a UL-MAP (uplink map), and information for controlling wireless communication performed by the wireless terminals 21 to 23, where the DL-MAP and the UL-MAP are generated by scheduling performed by the master wireless terminal 11, and respectively include information on the data mapping in the downlink interval and the uplink interval.

Each of the wireless terminals 21 to 23 receives the control information from the master wireless terminal 11 in the interval indicated in FIG. 4, and can recognize the location, in the downlink subframe, of data transmitted from the master wireless terminal 11 to the wireless terminal, on the basis of the DL-MAP contained in the received control information.

In addition, each of the wireless terminals 21 to 23 can recognize the location, in an uplink subframe, of data to be transmitted from the wireless terminal, on the basis of the UL-MAP contained in the received control information. The master wireless terminal 11 recognizes the location, in the uplink subframe, of the data transmitted from each of the wireless terminals 21 to 23, on the basis of the UL-MAP generated by the master wireless terminal 11, and receives the data transmitted from each of the wireless terminals 21 to 23.

In the time intervals for data (for example, as illustrated in FIG. 4), the master wireless terminal 11 transmits data to each of the wireless terminals 21 to 23 in accordance with the DL-MAP generated by the master wireless terminal 11, and each of the wireless terminals 21 to 23 receives the data transmitted from the master wireless terminal 11 and addressed to the wireless terminal, on the basis of the DL-MAP transmitted from the master wireless terminal 11 as explained before.

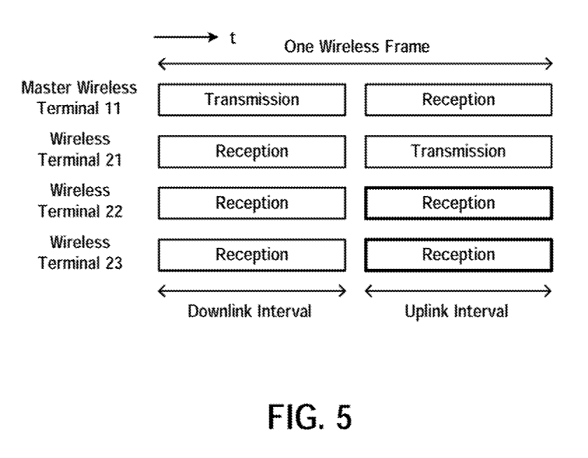

FIG. 5 illustrates time intervals of transmission and reception in a wireless frame in the case where a wireless terminal performs broadcast transmission in the wireless communication system according to the second embodiment. As illustrated in FIG. 5, in the case where one of the wireless terminals 11 and 21 to 23 performs broadcast transmission to other of the wireless terminals 11 and 21 to 23, transmission and reception of data in each wireless frame are performed in a time-shared manner similar to the case of FIG. 3. In the following explanations, it is assumed that the wireless terminal 21 performs broadcast transmission to the wireless terminals 11, 22, and 23.

Similarly to the case of FIG. 3, the time interval of each wireless frame is divided into the downlink interval and the uplink interval. In the downlink interval, data is transmitted from the master wireless terminal 11 to the wireless terminals 21 to 23. Although the uplink interval is originally a time interval for transmitting data from the wireless terminals 21 to 23 to the master wireless terminal 11, the operation mode of each of the wireless terminals 21 to 23 is switched to the reception mode even in the uplink interval. For example, when the wireless terminals 22 and 23 are instructed to receive broadcast data from the wireless terminal 21, the operation mode of the wireless terminals 22 and 23 is switched to the reception mode in order to receive the broadcast data from the wireless terminal 21.

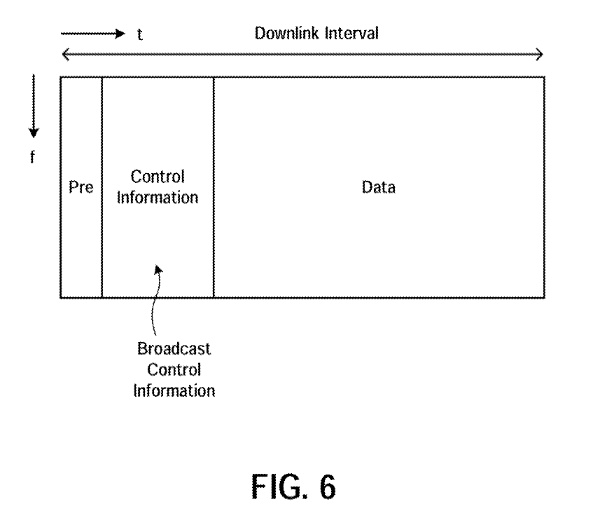

FIG. 6 illustrates an example of a structure of a wireless subframe in the downlink interval indicated in FIG. 5. (In FIG. 6, the abscissa indicates the progression of time, and the ordinate indicates the carrier frequency.) In the following explanations referring to FIG. 6, it is assumed that the wireless terminal 21 performs broadcast transmission to the wireless terminals 11, 22, and 23 in the uplink interval indicated in FIG. 5. As illustrated in FIG. 6, the wireless subframe in the downlink interval contains the time intervals for the preamble (indicated by “Pre” in FIG. 6), control information, and data.

In the time interval for the preamble, a preamble signal is transmitted from the master wireless terminal 11 to the wireless terminals 21 to 23 (which are subordinate to the master wireless terminal 11).

In the time interval for the control information, the control information is transmitted from the master wireless terminal 11 to the wireless terminals 21 to 23 in a similar manner to the case explained with reference to FIGS. 3 and 4. At this time, the UL-MAP contained in the control information includes broadcast control information. The broadcast control information instructs one of the wireless terminals 21 to 23 requesting broadcast communication to transmit broadcast data in the uplink interval, and instructs the other ones of the wireless terminals 21 to 23 to receive the broadcast data in the uplink interval. For example, the broadcast control information includes information such as one or more of the identifiers of the wireless terminals 21 to 23 and information indicating that the broadcast communication is to be performed.

The wireless terminals 21 to 23 receive the control information in the time interval for the control information in the downlink interval. Then, the wireless terminals 22 and 23 recognize, on the basis of the broadcast control information contained in the UL-MAP in the received control information, that the broadcast communication is to be performed in the uplink interval. The master wireless terminal 11 recognizes, on the basis of the UL-MAP in the control information produced by the master wireless terminal 11.

Assume that the wireless terminal 21 performs broadcast transmission to the wireless terminals 11, 22, and 23 in the uplink interval as mentioned before. In this case, the wireless terminal 21 (which is to perform broadcast transmission) transmits to the master wireless terminal 11 a request for the broadcast communication, in an uplink interval allocated by the master wireless terminal 11 to the wireless terminal 21.

When the master wireless terminal 11 receives from the wireless terminal 21 the request for the broadcast communication, the master wireless terminal 11 generates control information which enables the wireless terminal 21 to perform broadcast transmission in the uplink interval in the next wireless frame. The control information contains a UL-MAP containing broadcast control information as illustrated in FIG. 6, and the broadcast control information includes first information on the wireless terminal (21) which is to perform the broadcast communication, and second information indicating that the broadcast communication is to be performed. The control information generated by the master wireless terminal 11 is transmitted to the wireless terminals 21 to 23.

When the wireless terminal 21 receives the above control information from the master wireless terminal 11, the wireless terminal 21 recognizes that the wireless terminal 21 can perform broadcast transmission to the wireless terminals 11, 22, and 23 in the uplink interval, on the basis of the above-mentioned first and second information included in the broadcast control information contained in the control information transmitted from the master wireless terminal 11, where the first information indicates the wireless terminal 21, and the second information indicates that broadcast communication is to be performed.

On the other hand, when the wireless terminals 22 and 23 receive from the master wireless terminal 11 the control information containing the first and second information, the wireless terminals 22 and 23 recognize, on the basis of the first and second information, that the wireless terminals 22 and 23 are to switch the operation mode to the reception mode so that the wireless terminals 22 and 23 can receive broadcast data transmitted from the wireless terminal 21 in the uplink interval. In addition, on the basis of the broadcast control information in the control information generated by the master wireless terminal 11, the master wireless terminal 11 recognizes that the master wireless terminal 11 is to receive the broadcast data from the wireless terminal 21.

Thus, the wireless terminal 21 can transmit the broadcast data to the wireless terminals 22 and 23 in the uplink interval without relay by the master wireless terminal 11. Therefore, the power consumption in the master wireless terminal 11 can be reduced since the master wireless terminal 11 does not perform processing for receiving the broadcast data from the wireless terminal 21 and processing for transmitting the broadcast data to the wireless terminals 22 and 23.

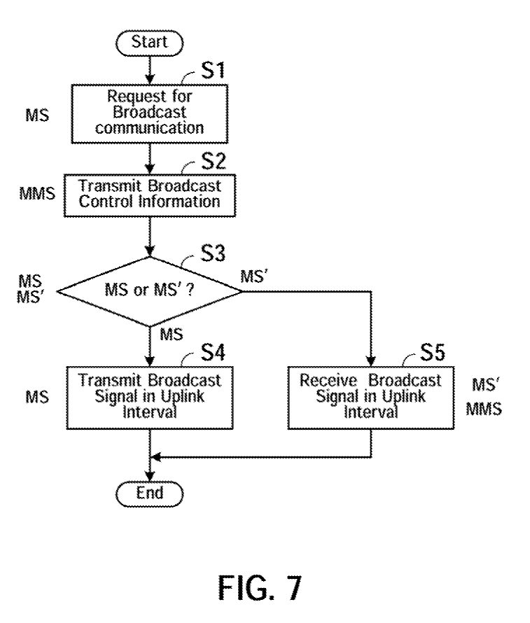

FIG. 7 indicates a flow of processing performed by one of the wireless terminals 21 to 23 and the master wireless terminal 11 for broadcast communication according to the second embodiment. In FIG. 7, each step bearing the indication “MS” is performed by one of the wireless terminals 21 to 23 which is requested to perform broadcast transmission, each step bearing the indication “MS′” is performed by the other ones of the wireless terminals 21 to 23, and each step bearing the indication “MMS” is performed by the master wireless terminal 11.

<Step S1> The one of the wireless terminals 21 to 23 which is requested to perform the broadcast transmission transmits to the master wireless terminal 11 a request for broadcast communication in an uplink interval which is allocated by the master wireless terminal 11 to the one of the wireless terminals 21 to 23. In the following explanations, it is assumed that the one of the wireless terminals 21 to 23 which is requested to perform the broadcast transmission is the wireless terminal 21.

<Step S2> When the master wireless terminal 11 receives the request for broadcast communication, the master wireless terminal 11 generates broadcast control information. The broadcast control information instructs the wireless terminal 21 to transmit broadcast data in the uplink interval, and instructs the wireless terminals 11, 22, and 23 to receive the broadcast data in the uplink interval. The master wireless terminal 11 includes the generated broadcast control information in a UL-MAP in control information, and transmits the control information to the wireless terminals 21 to 23 in the downlink interval.

<Step S3> On the basis of the broadcast control information included in the UL-MAP contained in the received control information, each of the wireless terminals 21 to 23 recognizes that broadcast communication is to be performed in the uplink interval, and determines whether or not the wireless terminal is the source in the transmission of the broadcast data. When yes is determined, the operation goes to step S4. When no is determined, the operation goes to step S5. In this example, the operation of the wireless terminal 21 goes to step S4 since the wireless terminal 21 is the source in the transmission of the broadcast data. On the other hand, the operation of the wireless terminals 22 and 23 goes to step S5 since the wireless terminals 22 and 23 are to receive the broadcast data.

<Step S4> The wireless terminal 21 performs broadcast transmission of the broadcast data (broadcast signal) in the uplink interval.

<Step S5> The wireless terminals 22 and 23 receive the broadcast data broadcasted from the wireless terminal 21 in the uplink interval. In addition, the master wireless terminal 11 also receives the broadcast data broadcasted from the wireless terminal 21 on the basis of the broadcast control information generated by the master wireless terminal 11.

As explained above, when the master wireless terminal 11 receives a request for broadcast communication from one of the wireless terminals 21 to 23 which is requested to perform the broadcast transmission, the master wireless terminal 11 transmits broadcast control information to the one of the wireless terminals 21 to 23. Then, the one of the wireless terminals 21 to 23 performs the broadcast transmission in the uplink interval on the basis of the broadcast control information. The other wireless terminals 22 and 23 which are to receive the broadcast data switch the operation mode to the reception mode in the uplink interval. Thus, the broadcast data can be transmitted and received by the wireless terminals 21 to 23 without being relayed by the master wireless terminal 11, so that the amount of processing performed by the master wireless terminal 11 and the electric power consumed in the master wireless terminal 11 for the broadcast communication can be reduced.

### 3. Third Embodiment

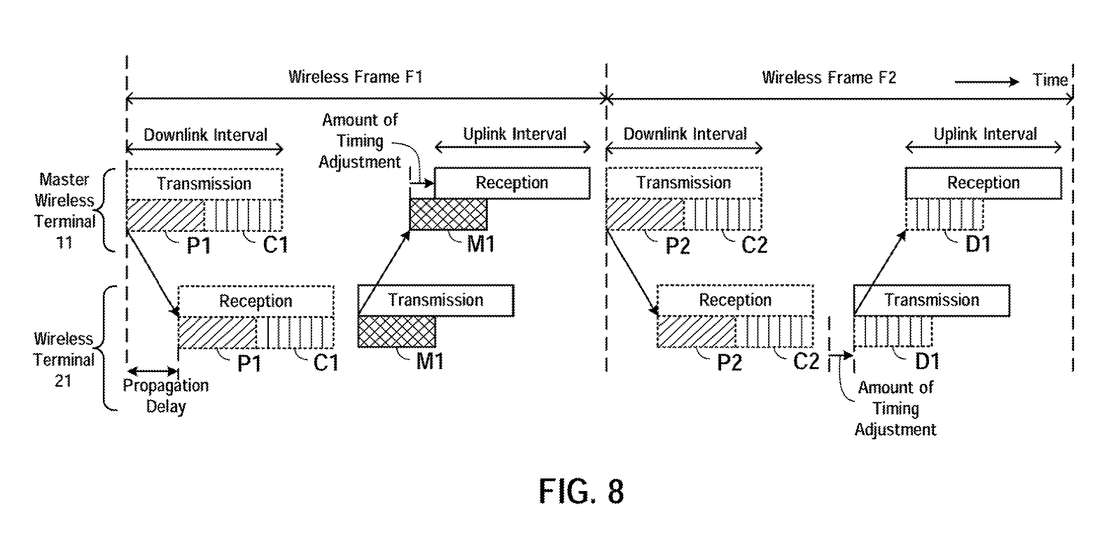

The third embodiment is explained in detail below with reference to FIGS. 8 to 11. The following explanations are focused on the timing adjustment of the wireless frame. Specifically, first, the timing adjustment in the cellular communication mode (i.e., in a communication mode in which one-to-one communication is performed between wireless terminals through a master wireless terminal) is explained, and then the timing adjustment in the broadcast communication mode (i.e., in a communication mode in which transmission from a wireless terminal to multiple wireless terminals is performed) is explained. In the following explanations on the third embodiment, a system configuration similar to the second embodiment is assumed.

FIG. 8 illustrates timing adjustment in the cellular communication mode according to the third embodiment. In FIG. 8, wireless frames which are transmitted between the master wireless terminal 11 and the wireless terminal 21 are illustrated.

As illustrated in FIG. 8, the master wireless terminal 11 transmits to the wireless terminal 21 (which is subordinate to the master wireless terminal 11) a preamble signal P1 and a control signal C1 in the downlink interval in the wireless frame F1. The control signal C1 contains an instruction to the wireless terminal 21 for transmission of a measurement reference signal. When the wireless terminal 21 receives the preamble signal P1 and the control signal C1 which are transmitted from the master wireless terminal 11, a propagation delay as illustrated in FIG. 8 occurs in the reception of the preamble signal P1 and the control signal C1, and the wireless terminal 21 transmits a measurement reference signal M1 to the master wireless terminal 11. When the master wireless terminal 11 receives the measurement reference signal M1 transmitted from the wireless terminal 21, the master wireless terminal 11 calculates an amount of timing adjustment, which corresponds to an offset of the received measurement reference signal M1 from an expected uplink interval (i.e., the time interval in which the master wireless terminal 11 is expected to receive data from the wireless terminal 21).

For example, when the measurement reference signal M1 from the wireless terminal 21 is received x samples in advance of the uplink interval expected by the master wireless terminal 11, the master wireless terminal 11 calculates the amount of timing adjustment so as to correct the advance of x samples in the transmission timing of the measurement reference signal M1 from the wireless terminal 21.

In the downlink interval in the next wireless frame F2, the master wireless terminal 11 transmits a preamble signal P2 and a control signal C2 to the wireless terminal 21 (which is subordinate to the master wireless terminal 11). The control signal C2 contains the calculated amount of timing adjustment. When the wireless terminal 21 receives the preamble signal P2 and the control signal C2 from the master wireless terminal 11, the wireless terminal 21 transmits a data signal D1 to the master wireless terminal 11. At this time, the wireless terminal 21 adjusts the timing of the transmission of the data signal D1 on the basis of the amount of timing adjustment contained in the control signal C2. For example, when the amount of timing adjustment is such an amount as to correct the advance of x samples in the measurement reference signal M1, the wireless terminal 21 transmits the data signal D1 at the timing x samples delayed from the timing of the transmission of the measurement reference signal M1. Thus, the master wireless terminal 11 can receive the data signal D1 (transmitted from the wireless terminal 21) in an appropriate uplink interval. In addition, the wireless terminals 22 and 23 can also make a timing adjustment similarly to the wireless terminal 21.

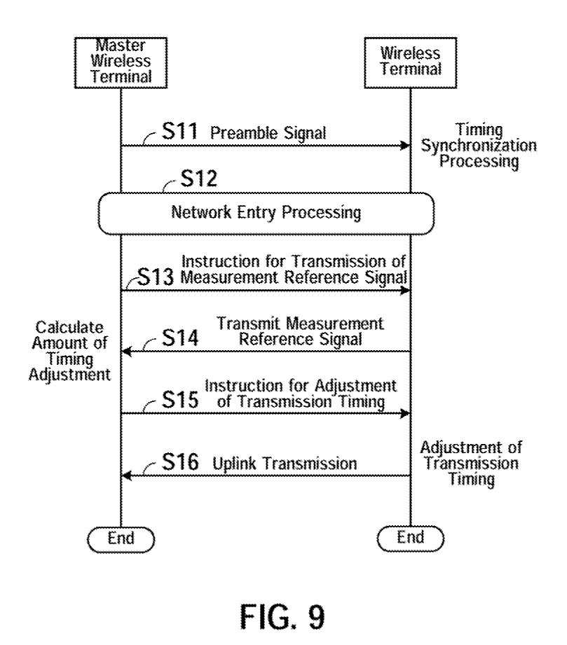

FIG. 9 indicates a sequence of operations performed for timing adjustment in the cellular communication mode according to the third embodiment.

<Step S11> The master wireless terminal 11 transmits a preamble signal to the wireless terminal 21 (which is subordinate to the master wireless terminal 11). The wireless terminal 21 performs processing for timing synchronization on the basis of the preamble signal transmitted from the master wireless terminal 11. For example, the wireless terminal 21 determines the leading edge of the downlink interval.

<Step S12> After the processing for timing synchronization, the wireless terminal 21 performs processing for network entry. Specifically, processing for authentication and registration is performed by the master wireless terminal 11 and the wireless terminal 21 for enabling the wireless terminal 21 to perform wireless communication in the wireless communication network illustrated in FIG. 2.

<Step S13> The master wireless terminal 11 transmits to the wireless terminal 21 an instruction for transmission of a measurement reference signal.

<Step S14> When the wireless terminal 21 receives the instruction for transmission of a measurement reference signal, the wireless terminal 21 transmits a measurement reference signal to the master wireless terminal 11. Then, the master wireless terminal 11 calculates the amount of timing adjustment on the basis of the measurement reference signal transmitted from the wireless terminal 21.

<Step S15> The master wireless terminal 11 transmits the calculated amount of timing adjustment to the wireless terminal 21, and instructs the wireless terminal 21 to adjust the transmission timing.

<Step S16> The wireless terminal 21 adjusts the timing of transmission of data to the master wireless terminal 11, on the basis of the amount of timing adjustment transmitted from the master wireless terminal 11 before performing uplink transmission.

Next, the timing adjustment in the broadcast communication mode is explained below.

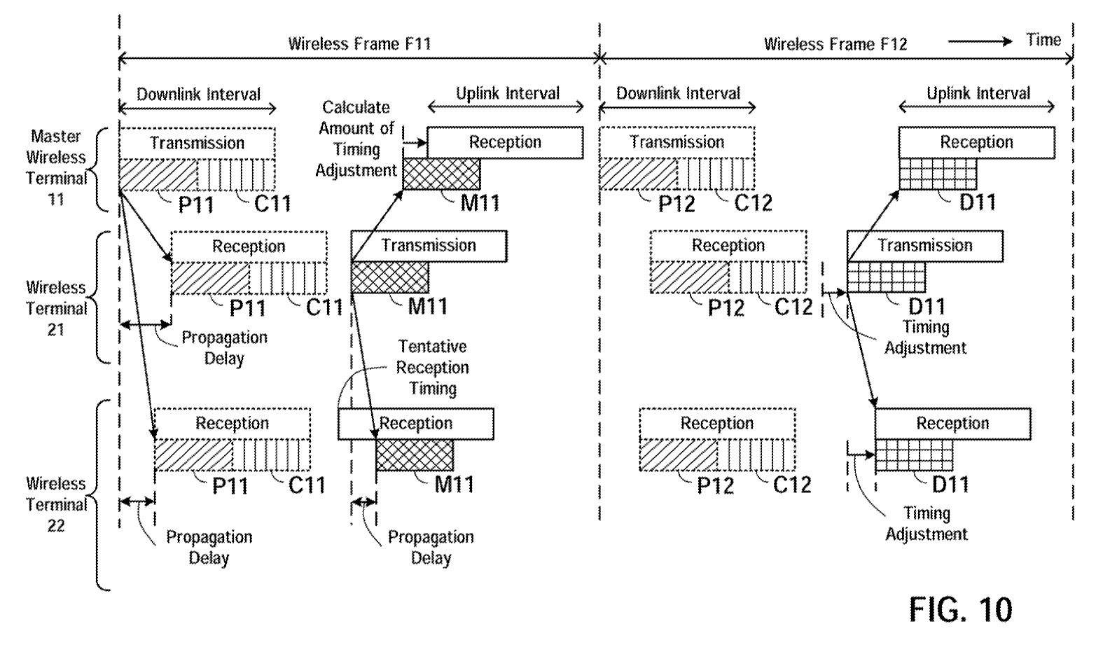

FIG. 10 illustrates timing adjustment in the broadcast communication mode according to the third embodiment. In FIG. 10, wireless frames which are transmitted and received by the master wireless terminal 11 and the wireless terminals 21 and 22 are illustrated, and it is assumed that the wireless terminal 21 is to transmit broadcast data, and the wireless terminal 22 is to receive the broadcast data from the wireless terminal 21.

As illustrated in FIG. 10, the master wireless terminal 11 transmits to the wireless terminals 21 and 22 (which are subordinate to the master wireless terminal 11) a preamble signal P11 and a control signal C11 in the downlink interval in the wireless frame F11. The control signal C11 contains an instruction to the wireless terminal 21 for transmission of a measurement reference signal. When the wireless terminals 21 and 22 receive the preamble signal P11 and the control signal C11 transmitted from the master wireless terminal 11, a propagation delay as illustrated in FIG. 10 occurs in the reception of the preamble signal P11 and the control signal C11 by the wireless terminals 21 and 22, and the wireless terminal 21 transmits a measurement reference signal M11 to the master wireless terminal 11. At this time, the wireless terminal 22, as well as the master wireless terminal 11, receives the measurement reference signal M11. A propagation delay as illustrated in FIG. 10 occurs in the reception of the master wireless terminal 11 by the wireless terminal 22, and the wireless terminal 22 memorizes the timing of the reception of the measurement reference signal M11 transmitted from the wireless terminal 21. For example, the wireless terminal 22 memorizes the timing of the reception of the measurement reference signal M11 with respect to the leading edge of a downlink interval which is determined on receipt of the preamble signal P11, and the timing of the reception is represented, for example, by the number of samples counted from the leading edge of the downlink interval.

When the master wireless terminal 11 receives the measurement reference signal M11 from the wireless terminal 21, the master wireless terminal 11 calculates the amount of timing adjustment, which corresponds to an offset of the received measurement reference signal M11 from an expected uplink interval.

In the downlink interval in the next wireless frame F12, the master wireless terminal 11 transmits a preamble signal P12 and a control signal C12 to the wireless terminals 21 and 22 (which are subordinate to the master wireless terminal 11). The control signal C12 contains the calculated amount of timing adjustment. When the wireless terminal 21 receives the preamble signal P12 and the control signal C12 from the master wireless terminal 11, the wireless terminal 21 broadcasts a broadcast signal D11 to the master wireless terminal 11 and the wireless terminal 22. At this time, the wireless terminal 21 adjusts the timing of the broadcast transmission of the broadcast signal D11 on the basis of the amount of timing adjustment contained in the control signal C12.

On the other hand, the wireless terminal 22 adjusts the timing of reception of the broadcast signal D11 transmitted from the master wireless terminal 11, on the basis of the timing of the reception of the measurement reference signal M11 memorized in the wireless terminal 22 and the amount of timing adjustment contained in the control signal C12 transmitted from the master wireless terminal 11. Then, the wireless terminal 22 receives the broadcast signal D11 at the adjusted timing.

For example, in the case where the master wireless terminal 11 calculates that the timing of the transmission of the measurement reference signal M11 from the wireless terminal 21 is x samples in advance of the uplink interval expected by the master wireless terminal 11, the wireless terminal 22 adjusts the timing of reception of the broadcast signal D11 transmitted from the wireless terminal 21, to the timing which is x samples delayed from the timing of the reception of the measurement reference signal M11 memorized in the wireless terminal 22.

Thus, the wireless terminal 22 can receive the broadcast signal D11 transmitted from the wireless terminal 21, at an appropriate timing. Although the wireless terminal 23 is not mentioned in the above explanations, the wireless terminal 23 can also adjust the timing of reception in a similar manner to the wireless terminal 22.

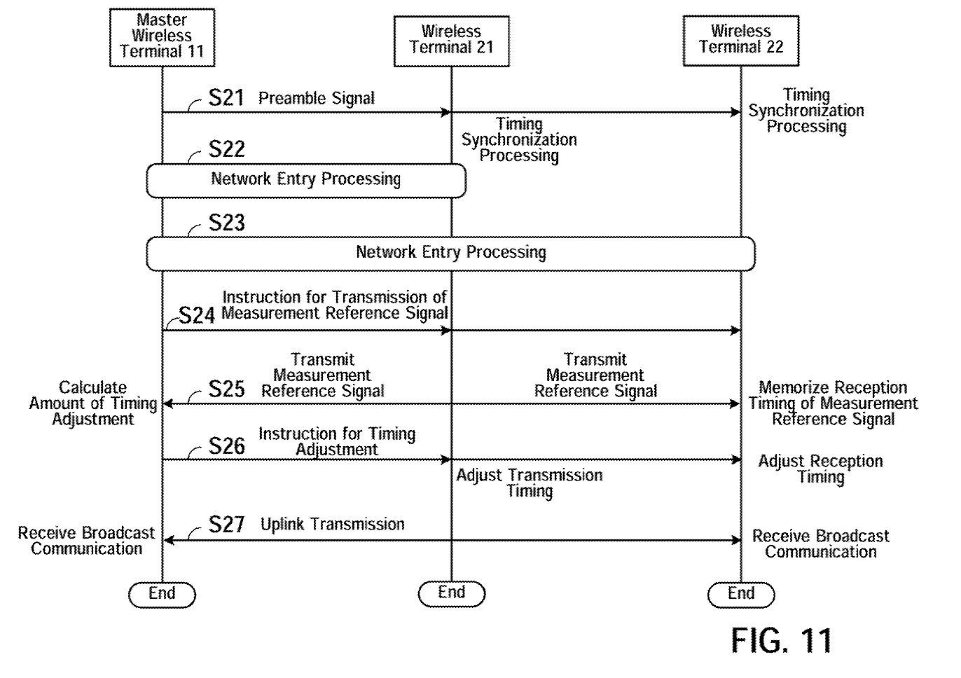

FIG. 11 indicates a sequence of operations performed by the master wireless terminal 11 and the wireless terminals 21 and 22 for timing adjustment in the broadcast communication mode according to the third embodiment. In the following explanations, it is assumed that the wireless terminal 21 is to transmit broadcast data, and the master wireless terminal 11 and the wireless terminal 22 are to receive the broadcast data from the wireless terminal 21.

<Step S21> The master wireless terminal 11 transmits a preamble signal to the wireless terminals 21 and 22 (which are subordinate to the master wireless terminal 11). The wireless terminals 21 and 22 perform processing for timing synchronization on the basis of the preamble signal transmitted from the master wireless terminal 11. For example, the wireless terminals 21 and 22 determine the leading edge of the downlink interval.

<Step S22> After the processing for timing synchronization, the wireless terminal 21 performs processing for network entry. Specifically, processing for authentication and registration is performed by the master wireless terminal 11 and the wireless terminal 21 for enabling the wireless terminal 21 to perform wireless communication in the wireless communication network illustrated in FIG. 2.

<Step S23> After the processing for timing synchronization, the wireless terminal 22 performs processing for network entry. Specifically, processing for authentication and registration is performed by the master wireless terminal 11 and the wireless terminal 22 for enabling the wireless terminal 22 to perform wireless communication in the wireless communication network illustrated in FIG. 2.

<Step S24> The master wireless terminal 11 transmits to the wireless terminal 21 an instruction for transmission of a measurement reference signal. At this time, both of the wireless terminals 21 and 22 receive the instruction for transmission of a measurement reference signal transmitted from the master wireless terminal 11.

<Step S25> When the wireless terminal 21 receives the instruction for transmission of a measurement reference signal, the wireless terminal 21 transmits a measurement reference signal to the master wireless terminal 11. Then, the master wireless terminal 11 calculates the amount of timing adjustment on the basis of the measurement reference signal transmitted from the wireless terminal 21. The wireless terminal 22 memorizes the timing of the reception of the measurement reference signal transmitted from the wireless terminal 21.

<Step S26> The master wireless terminal 11 transmits the calculated amount of timing adjustment to the wireless terminal 21, and instructs the wireless terminal 21 to adjust the transmission timing. At this time, the wireless terminal 22 also receives the amount of timing adjustment.

The wireless terminal 21 adjusts the timing of transmission of a broadcast (data) signal to the master wireless terminal 11 and the wireless terminal 22, on the basis of the amount of timing adjustment transmitted from the master wireless terminal 11, and the wireless terminal 22 adjusts the timing of reception of the broadcast signal to be transmitted from the wireless terminal 21, on the basis of the memorized timing of reception of the measurement reference signal and the amount of timing adjustment transmitted from the master wireless terminal 11.

<Step S27> The wireless terminal 21 transmits the broadcast signal to the master wireless terminal 11 and the wireless terminal 22 at the adjusted timing of transmission, and the wireless terminal 22 receives the broadcast signal transmitted from the wireless terminal 21, at the adjusted timing of reception.

As explained above, the wireless terminal 21 (which is to perform broadcast transmission) performs operations similar to the operations for the timing adjustment performed in cooperation with the master wireless terminal 11 in the cellular communication mode, and the wireless terminal 22 (which is to receive the broadcast signal) adjusts the timing of reception in the uplink interval in the broadcast communication mode. In addition, the wireless terminals 21 and 22 perform the above operations in parallel. Thus, it is possible to realize synchronization processing for broadcast communication between the wireless terminals 21 and 22.

Alternatively, the calculation of the amount of timing adjustment, the adjustment of the timing of transmission, and the adjustment of the timing of reception may be performed on the basis of time, instead of the number of samples.

### 4. Fourth Embodiment

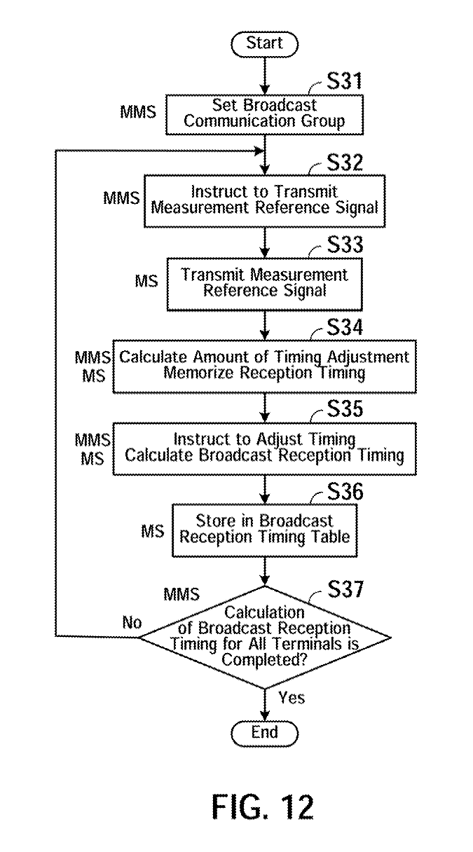

The fourth embodiment is explained in detail below with reference to FIGS. 12 to 14. According to the fourth embodiment, timing adjustment for broadcast communication is performed in each of the wireless terminals belonging to the wireless communication network of FIG. 2, although a similar system configuration to FIG. 2 is assumed in the following explanations on the fourth embodiment.

FIG. 12 indicates a flow of processing for broadcast communication according to the fourth embodiment. In FIG. 12, each step bearing the indication “MS” is performed by each of the wireless terminals 21 to 23, and each step bearing the indication “MMS” is performed by the master wireless terminal 11. In the following explanations, it is assumed that the processing for network entry of the wireless terminals 21 to 23 is already performed.

<Step S31> The master wireless terminal 11 determines a broadcast communication group. For example, the broadcast communication group consists of one or more of the wireless terminals 21 to 23 which have a function of performing broadcast transmission and have already performed the processing for network entry.

<Step S32> The master wireless terminal 11 transmits to one of the wireless terminals belonging to the broadcast communication group an instruction for transmission of a measurement reference signal.

<Step S33> When the one of the wireless terminals receives from the master wireless terminal 11 the instruction for transmission of a measurement reference signal, the wireless terminal transmits a measurement reference signal to the master wireless terminal 11 and the other ones of the wireless terminals 21 to 23. (For example, when the wireless terminal 21 receives from the master wireless terminal 11 the instruction for transmission of a measurement reference signal, the wireless terminal 21 transmits a measurement reference signal to the master wireless terminal 11 and the wireless terminals 22 and 23.)

<Step S34> When the master wireless terminal 11 receives the measurement reference signal from the one of the wireless terminals belonging to the broadcast communication group, the master wireless terminal 11 calculates an amount of timing adjustment on the basis of the received measurement reference signal. At this time, each of the other ones of the wireless terminals also receives the measurement reference signal, and memorizes the timing of the reception of the measurement reference signal. (For example, when the wireless terminal 21 transmits a measurement reference signal in response to the instruction for transmission of a measurement reference signal, each of the wireless terminals 22 and 23 receives the measurement reference signal, and memorizes the timing of the reception of the measurement reference signal.)

<Step S35> The master wireless terminal 11 transmits a calculated amount of timing adjustment to the one of the wireless terminals belonging to the broadcast communication group, and instructs the one of the wireless terminals to adjust the transmission timing. Then, the one of the wireless terminals 21 to 23 belonging to the broadcast communication group stores, in a memory, the amount of timing adjustment transmitted from the master wireless terminal 11.

In addition, each of the other ones of the wireless terminals (which are not instructed by the master wireless terminal 11 to transmit a measurement reference signal) calculates the timing of reception of broadcast data to be transmitted from the one of the wireless terminals belonging to the broadcast communication group (which receives the instruction for transmission of a measurement reference signal), on the basis of the amount of timing adjustment transmitted from the master wireless terminal 11 and the timing of the reception of the measurement reference signal memorized in step S34. For example, in the case where the wireless terminal 21 is the one of the wireless terminals belonging to the broadcast communication group, the wireless terminal 22 (which are not instructed by the master wireless terminal 11 to transmit a measurement reference signal) calculates the timing of reception of broadcast data to be transmitted from the wireless terminal 21, on the basis of the amount of timing adjustment transmitted from the master wireless terminal 11 and the timing of the reception of the measurement reference signal memorized in step S34.

<Step S36> Each of the other ones of the wireless terminals (which are not instructed by the master wireless terminal 11 to transmit a measurement reference signal) stores, in a broadcast reception timing table, the calculated timing of reception of broadcast data in correspondence with the one of the wireless terminals belonging to the broadcast communication group (which receives from the master wireless terminal 11 the instruction for transmission of a measurement reference signal). For example, in the case where the wireless terminal 21 is the one of the wireless terminals belonging to the broadcast communication group (which receives from the master wireless terminal 11 the instruction for transmission of a measurement reference signal), each of the wireless terminals 22 and 23 (which are not instructed by the master wireless terminal 11 to transmit a measurement reference signal) stores, in the broadcast reception timing table, the calculated timing of reception of broadcast data in correspondence with the wireless terminal 21.

<Step S37> The master wireless terminal 11 determines whether or not the timing of reception of broadcast data is already calculated on the basis of the measurement reference signal transmitted from every one of the wireless terminals belonging to the broadcast communication group. When yes is determined in step S37, the processing of FIG. 12 is completed. When no is determined in step S37, the operation goes to step S32, and the instruction for transmission of a measurement reference signal is transmitted, in step S32, to another of the wireless terminals belonging to the broadcast communication group to which the instruction for transmission of a measurement reference signal is not yet transmitted.

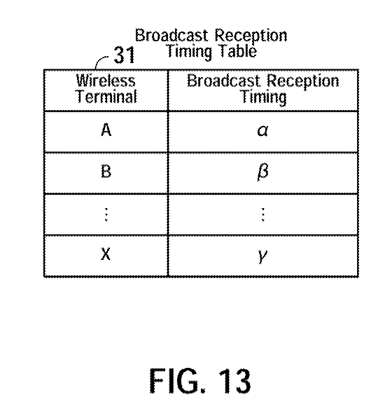

FIG. 13 illustrates an example of a data structure of the broadcast reception timing table according to the fourth embodiment. The broadcast reception timing table 31 illustrated in FIG. 13 is assumed to be arranged in the wireless terminal 21. (Although not illustrated, each of the wireless terminals 22 and 23 also has a similar broadcast reception timing table.) As illustrated in FIG. 13, the broadcast reception timing table 31 has the column “Wireless Terminal” and the column “Timing of Broadcast Reception.” For example, the identifiers of the wireless terminals 22 and 23 are recorded in the column “Wireless Terminal”, and the timing of reception of a broadcast signal to be transmitted from each of the wireless terminals 22 and 23 are recorded in the column “Timing of Broadcast Reception.” For example, in the case where the wireless terminal 22 is to transmit a broadcast signal, the wireless terminal 21 refers to the broadcast reception timing table 31, and acquires the timing of broadcast reception corresponding to the wireless terminal 22. Then, the wireless terminal 21 receives a broadcast signal transmitted from the wireless terminal 22, at the acquired timing of broadcast reception.

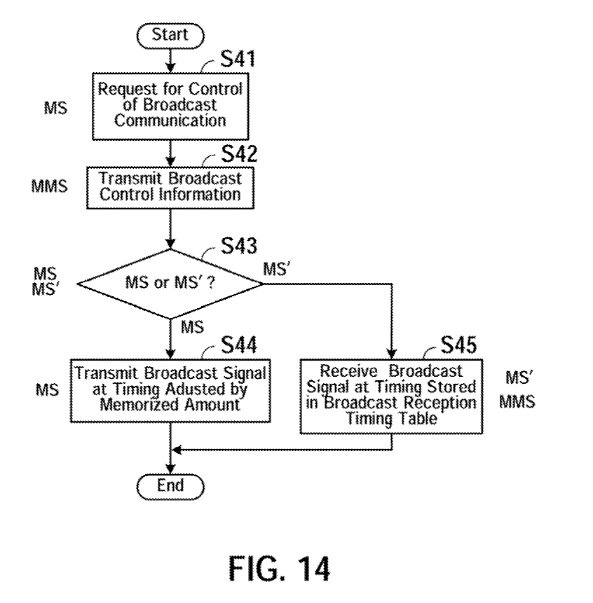

FIG. 14 indicates a flow of processing performed by wireless terminals and the master wireless terminal for broadcast communication according to the fourth embodiment. In FIG. 14, each step bearing the indication “MS” is performed by one of the wireless terminals 21 to 23 which is requested to perform broadcast transmission, each step bearing the indication “MS′” is performed by the other ones of the wireless terminals 21 to 23, and each step bearing the indication “MMS” is performed by the master wireless terminal 11.

<Step S41> One of the wireless terminals 21 to 23 which is requested to perform broadcast transmission transmits to the master wireless terminal 11 a request for broadcast communication in an uplink interval which is allocated by the master wireless terminal 11 to the one of the wireless terminals 21 to 23. In the following explanations, it is assumed that the one of the wireless terminals 21 to 23 which is requested to perform the broadcast transmission is the wireless terminal 23.

<Step S42> When the master wireless terminal 11 receives from the wireless terminal 23 the request for broadcast communication, the master wireless terminal 11 generates broadcast control information. The broadcast control information instructs the wireless terminal 23 to transmit broadcast data in the uplink interval, and instructs the wireless terminals 11, 21, and 22 to receive the broadcast data in the uplink interval. The master wireless terminal 11 includes the generated broadcast control information in a UL-MAP in control information, and transmits the control information to the wireless terminals 21 to 23 in the downlink interval.

<Step S43> On the basis of the broadcast control information included in the UL-MAP contained in received control information, each of the wireless terminals 21 to 23 recognizes that broadcast communication is to be performed in the uplink interval, and determines whether or not the wireless terminal is the source in transmission of the broadcast data. When yes is determined, the operation goes to step S44. When no is determined, the operation goes to step S45. In this example, the operation of the wireless terminal 23 goes to step S44 since the wireless terminal 23 is the source in transmission of the broadcast data. On the other hand, the operation of the wireless terminals 21 and 22 goes to step S45 since the wireless terminals 21 and 22 are to receive the broadcast data.

<Step S44> The wireless terminal 23 performs broadcast transmission of the broadcast data (broadcast signal) to the wireless terminals 11, 21, and 22 in the uplink interval. At this time, the wireless terminal 23 adjusts the timing of the transmission of the broadcast data on the basis of the amount of timing adjustment stored in the memory in the wireless terminal 23.

<Step S45> The wireless terminals 21 and 22 receive the broadcast data transmitted from the wireless terminal 23 in the uplink interval. At this time, the wireless terminals 21 and 22 acquires the timing of broadcast reception corresponding to the wireless terminal 23 and being stored in the broadcast reception timing table 31, and receives the broadcast data at the acquired timing. In addition, the master wireless terminal 11 also receives the broadcast data transmitted from the wireless terminal 23 on the basis of the broadcast control information generated by the master wireless terminal 11.

As explained above, since each of the wireless terminals 21 to 23 memorizes the timing of broadcast reception in the wireless terminal, the wireless terminals 21 to 23 can appropriately receive the broadcast data whichever of the wireless terminals 21 to 23 obtains the rights to perform broadcast transmission and transmits the broadcast data.

### 5. Fifth Embodiment

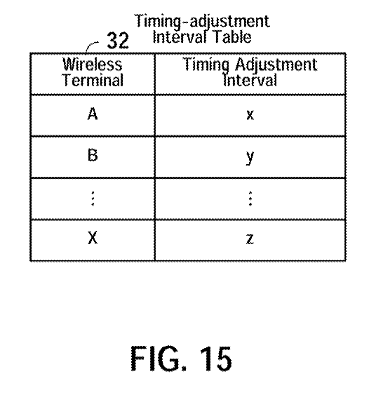

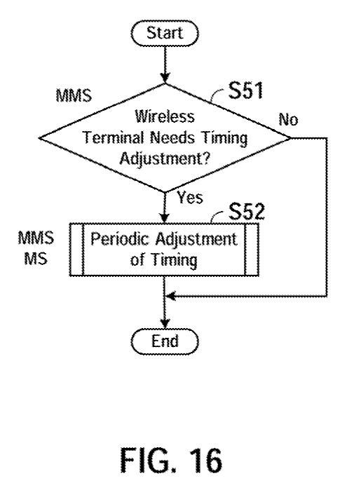

The fifth embodiment is explained in detail below with reference to FIGS. 15 and 16. The amount of timing adjustment for each terminal and the timing of reception by each terminal vary with the location of the wireless terminal. When the wireless terminal moves, the amount of timing adjustment for and the timing of reception by each terminal vary with time. Further, the movement speed of each wireless terminal is different. According to the fifth embodiment, timing adjustment is performed at predetermined regular intervals.

FIG. 15 illustrates an example of a data structure of a timing-adjustment interval table according to the fifth embodiment. The timing-adjustment interval table 32 illustrated in FIG. 15 is arranged in the master wireless terminal 11. As illustrated in FIG. 15, the timing-adjustment interval table 32 has the column “Wireless Terminal” and the column “Timing-adjustment Interval.” For example, the identifiers of the wireless terminals 21 to 23 are recorded in the column “Wireless Terminal”, and the timing-adjustment interval of each of the wireless terminals 21 to 23 (i.e., the intervals at which the timing adjustment is to be performed by each of the wireless terminals 21 to 23) is recorded in the column “Timing Adjustment Interval.” For example, the timing-adjustment interval table 32 of FIG. 15 indicates that the timing-adjustment interval of the wireless terminal 21 having the identifier “A” is “x”.

The master wireless terminal 11 recognizes the intervals at which the timing adjustment is to be performed by the wireless terminals 21 to 23, by reference to the timing-adjustment interval table 32. When the time at which each of the wireless terminals 21 to 23 is to perform the timing adjustment comes, the master wireless terminal 11 transmits to the wireless terminal an instruction for transmission of a measurement reference signal. For example, when the master wireless terminal 11 recognizes, by reference to the timing-adjustment interval table 32, that the time at which the wireless terminal 21 is to perform the timing adjustment comes, the master wireless terminal 11 transmits to the wireless terminal 21 an instruction for transmission of a measurement reference signal. On receipt of the instruction, the wireless terminal 21 transmits a measurement reference signal. Thereafter, the wireless terminal 21 receives an updated amount of timing adjustment from the master wireless terminal 11. Similarly, the wireless terminals 22 and 23 also receives the updated amount of timing adjustment, and updates the timing of broadcast reception corresponding to the wireless terminal 21, which is stored in the timing-adjustment interval table 32.

The timing-adjustment interval is set so as to decrease with increase in the movement speed since the variations in the location of each wireless terminal increase with the movement speed.

In addition, the master wireless terminal 11 can change the values of the timing-adjustment interval for the wireless terminals 21 to 23. For example, the master wireless terminal 11 periodically receives the movement speeds of the wireless terminals 21 to 23 from the wireless terminals, and changes the values of the timing-adjustment interval stored in the timing-adjustment interval table 32 on the basis of the received movement speeds.

FIG. 16 indicates a flow of processing for periodically performing timing adjustment according to the fifth embodiment. In FIG. 16, each step bearing the indication “MS” is performed by each of the wireless terminals 21 to 23, and each step bearing the indication “MMS” is performed by the master wireless terminal 11. The processing of FIG. 16 is performed after the processing of FIG. 12 is performed once.

<Step S51> The master wireless terminal 11 determines, by reference to the timing-adjustment interval table 32, whether or not a wireless terminal of which timing adjustment is to be performed exists. When yes is determined, the operation goes to step S52. When no is determined, the processing of FIG. 16 is completed.

<Step S52> The master wireless terminal 11 transmits an instruction for transmission of a measurement reference signal, to a wireless terminal of which timing adjustment is to be performed. For example, when the master wireless terminal 11 determines, in step S51, that timing adjustment of the wireless terminal 21 is to be performed, the master wireless terminal 11 transmits to the wireless terminal 21 an instruction for transmission of a measurement reference signal. Thereafter, operations similar to the operations in step S34 to S36 in FIG. 12 are performed.

As explained above, the timing adjustment of the wireless terminals 21 to 23 is periodically performed according to the fifth embodiment, so that it is possible to cope with variations in the transmission timing in the wireless terminals 21 to 23, and the broadcast data can be appropriately transmitted and received.

### 6. Sixth Embodiment

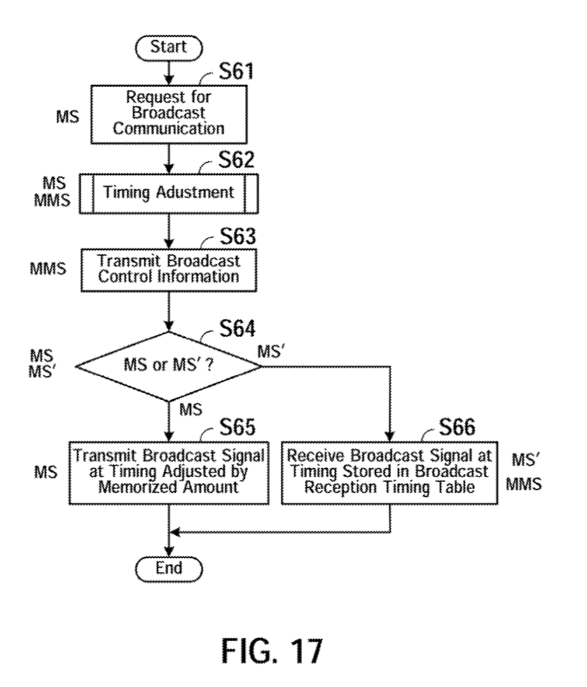

The sixth embodiment is explained in detail below with reference to FIG. 17. According to the sixth embodiment, the timing adjustment is performed when broadcast communication is requested.

FIG. 17 indicates a flow of processing performed for timing adjustment in the broadcast communication mode according to the sixth embodiment. In FIG. 17, each step bearing the indication “MS” is performed by one of the wireless terminals 21 to 23 which is requested to perform broadcast transmission, each step bearing the indication “MS′” is performed by the other ones of the wireless terminals 21 to 23, and each step bearing the indication “MMS” is performed by the master wireless terminal 11. In the following explanations, it is assumed that the broadcast communication group consists of the wireless terminals 11 and 21 to 23. When the master wireless terminal 11 receives from one of the wireless terminals 21 to 23 a request for broadcast communication, broadcast communication is performed between the wireless terminals 11 and 21 to 23.

<Step S61> One of the wireless terminals 21 to 23 which is requested to perform broadcast transmission transmits to the master wireless terminal 11 a request for broadcast communication in an uplink interval which is allocated by the master wireless terminal 11 to the one of the wireless terminals 21 to 23. In the following explanations, it is assumed that the one of the wireless terminals 21 to 23 which is requested to perform the broadcast transmission is the wireless terminal 21.

<Step S62> The master wireless terminal 11 transmits an instruction for transmission of a measurement reference signal, to the wireless terminal 21 (which transmits the request for broadcast communication). Thereafter, operations similar to the operations in step S34 to S36 in FIG. 12 are performed. Thus, the wireless terminal 21 (which is to perform broadcast transmission) performs timing adjustment so that the broadcast data is appropriately received by the master wireless terminal 11. In addition, the wireless terminals 22 and 23 (which are to receive the broadcast data) adjust the timing of reception so that the wireless terminals 22 and 23 can appropriately receive the broadcast data.

<Step S63> The master wireless terminal 11 generates broadcast control information. The broadcast control information instructs the wireless terminal 21 to transmit broadcast data in the uplink interval, and instructs the wireless terminals 11, 22, and 23 to receive the broadcast data in the uplink interval. The master wireless terminal 11 includes the generated broadcast control information in a UL-MAP in control information, and transmits the control information to the wireless terminals 21 to 23 in the downlink interval.

<Step S64> On the basis of the broadcast control information included in the UL-MAP contained in received control information, each of the wireless terminals 21 to 23 recognizes that broadcast communication is to be performed in the uplink interval, and determines whether or not the wireless terminal is the source in transmission of the broadcast data. When yes is determined, the operation goes to step S65. When no is determined, the operation goes to step S66. In this example, the operation of the wireless terminal 21 goes to step S65 since the wireless terminal 21 is the source in transmission of the broadcast data. On the other hand, the operation of the wireless terminals 22 and 23 goes to step S66 since the wireless terminals 22 and 23 are to receive the broadcast data.

<Step S65> The wireless terminal 21 performs broadcast transmission of the broadcast data (broadcast signal) to the wireless terminals 11, 22, and 23 in the uplink interval. At this time, the wireless terminal 21 adjusts the timing of the transmission of the broadcast data on the basis of the amount of timing adjustment stored in the memory in the memory.

<Step S66> The wireless terminals 22 and 23 receive the broadcast data transmitted from the wireless terminal 21 in the uplink interval. At this time, the wireless terminals 22 and 23 acquires the timing of broadcast reception corresponding to the wireless terminal 21 and being stored in the broadcast reception timing table 31, and receives the broadcast data at the acquired timing. In addition, the master wireless terminal 11 also receives the broadcast data transmitted from the wireless terminal 21 on the basis of the broadcast control information generated by the master wireless terminal 11.

As explained above, according to the sixth embodiment, the master wireless terminal 11 performs timing adjustment when the master wireless terminal 11 receives from one of the wireless terminals 21 to 23 a request for broadcast communication. Therefore, it is possible to appropriately transmit and receive broadcast data even when the locations of the wireless terminals change.

### 7. Construction of Wireless Terminals

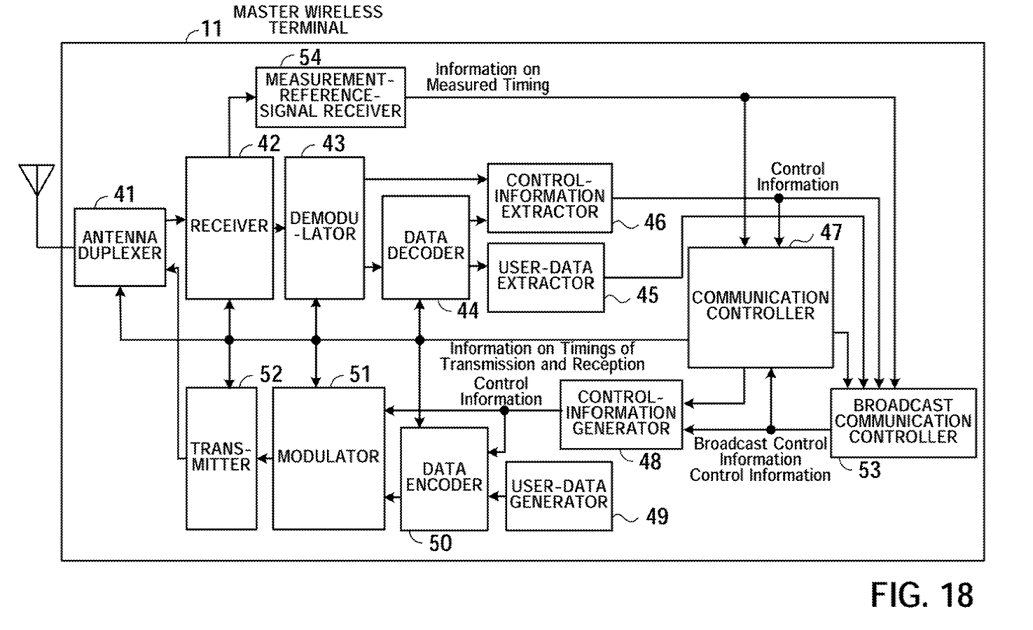

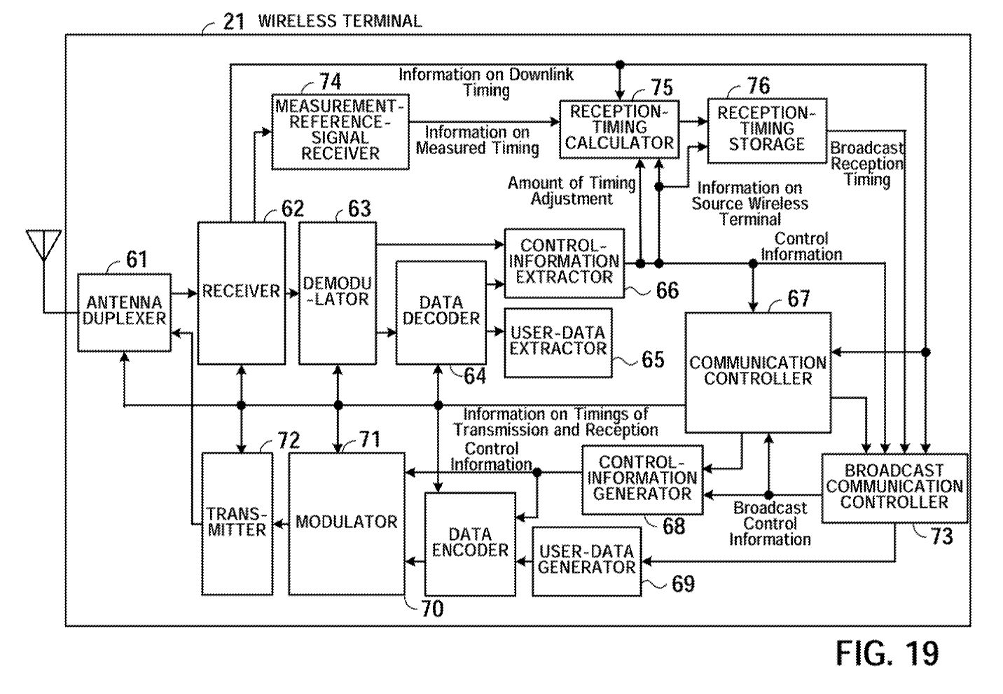

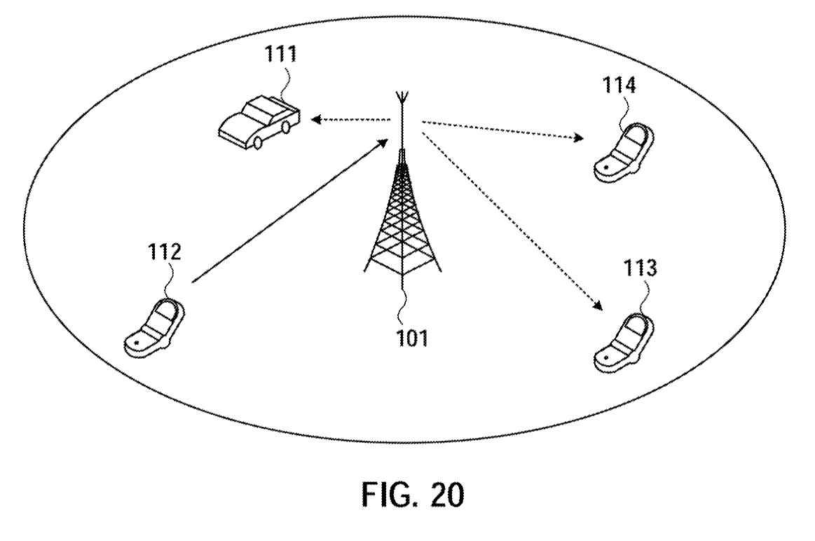

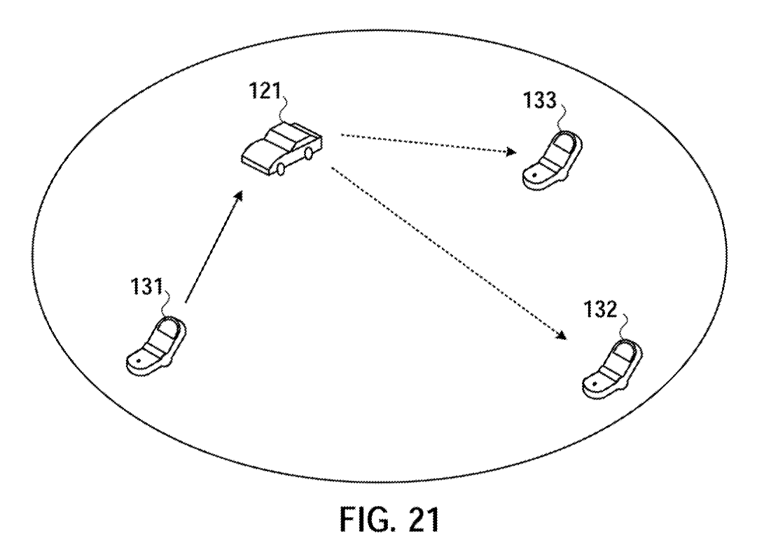

Hereinbelow, the constructions of wireless terminals which realizes the operations according to the second to sixth embodiments are explained below with reference to FIGS. 18 and 19.

FIG. 18 is a block diagram illustrating a construction of the master wireless terminal. In FIG. 18, the antenna duplexer 41 switches the operation mode of the master wireless terminal 11 between the transmission mode and the reception mode according to information on the timings of transmission and reception in each wireless frame. Alternatively, an antenna may be provided for each of transmission and reception.

The receiver 42 comprises, for example, a receiver amplifier, a filter, a frequency converter, an analog-to-digital converter, and an orthogonal converter, and converts a received RF (radio frequency) signal into a digital baseband signal. The demodulator 43 analyzes the control information transmitted to the master wireless terminal 11, in a predetermined manner, and demodulates the received signal on the basis of the result of the analysis. The data decoder 44 decodes the demodulated signal outputted from the demodulator 43. The user-data extractor 45 extracts user data from the signal decoded by the data decoder 44. That is, the user-data extractor 45 extracts user data transmitted from the wireless terminals 21 to 23. The control-information extractor 46 extracts the control information from the demodulated signal outputted from the demodulator 43, on the basis of a signal outputted from the data decoder 44.

The communication controller 47 generates the information on the timings of transmission and reception on the basis of information including an instruction from an upper layer such as a communication application, the control information extracted from the received signal, and the broadcast control information (which is outputted from the broadcast communication controller 53), and controls the operations of the respective portions of the master wireless terminal 11.

The control-information generator 48 generates the control information on the basis of the information outputted from the communication controller 47 and the broadcast communication controller 53. The user-data generator 49 generates data to be transmitted to a user (e.g., data for voice call or data communication).

The data encoder 50 encodes the user data and the control information. The modulator 51 modulates the data outputted from the data encoder 50, on the basis of the control information outputted from the control-information generator 48. The transmitter 52 comprises a transmitter amplifier, a filter, a frequency converter, an digital-to-analog converter, and an orthogonal converter, and converts the baseband signal outputted from the modulator 51, into an RF signal.

The broadcast communication controller 53 controls the processing for broadcast communication. Specifically, when the master wireless terminal 11 receives from one of the wireless terminals 21 to 23 a request for broadcast communication, the broadcast communication controller 53 generates the broadcast control information, and controls the respective portions of the master wireless terminal 11 so as to transmit the broadcast control information to the one of the wireless terminals 21 to 23 in the downlink interval. In addition, the broadcast communication controller 53 generates information for transmitting to one of the wireless terminals 21 to 23 an instruction for transmission of a measurement reference signal (for adjustment of transmission timing). The instruction contains control information which instructs the one of the wireless terminals 21 to 23 to transmit a measurement reference signal in a specific region of a wireless frame.

Further, the broadcast communication controller 53 calculates the amount of timing adjustment for the one of the wireless terminals 21 to 23 on the basis of information on a measured timing. Furthermore, in order to realize the fifth embodiment, the broadcast communication controller 53 can generate information for transmitting to the wireless terminals 21 to 23 an instruction for transmission of a measurement reference signal at intervals which are different for each of the wireless terminals 21 to 23. Moreover, in order to realize the sixth embodiment, the broadcast communication controller 53 can control the respective portions of the master wireless terminal 11 so that each of the wireless terminals 21 to 23 performs timing adjustment when the master wireless terminal 11 receives a request for broadcast communication from the wireless terminal. The measurement-reference-signal receiver 54 receives the measurement reference signal, and outputs, as the information on the measured timing, information on the timing of the reception of the measurement reference signal.

FIG. 19 is a block diagram illustrating a construction of the wireless terminal 21. Although not illustrated, each of the wireless terminals 22 and 23 has a similar construction to the wireless terminal 21. In FIG. 19, the antenna duplexer 61 switches the operation mode of the wireless terminal 21 between the transmission mode and the reception mode according to information on the timings of transmission and reception in each wireless frame. Alternatively, an antenna may be provided for each of transmission and reception.

The receiver 62 comprises, for example, a receiver amplifier, a filter, a frequency converter, an analog-to-digital converter, and an orthogonal converter, and converts a received RF (radio frequency) signal into a digital baseband signal. The receiver 62 extracts from the preamble signal information on a downlink timing, which is used as a reference timing by the respective portions of the wireless terminal 21. For example, the information on the downlink timing indicates the leading edge of the downlink interval.

The demodulator 63 analyzes, in a predetermined manner, control information transmitted to the wireless terminal 21, and demodulates the received signal on the basis of the result of the analysis. The data decoder 64 decodes the demodulated signal outputted from the demodulator 63. The user-data extractor 65 extracts user data from the signal decoded by the data decoder 64. That is, the user-data extractor 65 extracts user data transmitted from the other ones of the wireless terminals 21 to 23. The control-information extractor 66 extracts the control information from the demodulated signal outputted from the demodulator 63, on the basis of a signal outputted from the data decoder 64.

The communication controller 67 generates the information on the timings of transmission and reception on the basis of information including an instruction from an upper layer such as a communication application, the control information extracted from the received signal, and the broadcast control information (which is outputted from the broadcast communication controller 73), and controls the operations of the respective portions of the wireless terminal 21.

The control-information generator 68 generates the control information on the basis of the information outputted from the communication controller 67 and the broadcast communication controller 73. The user-data generator 69 generates data to be transmitted by a user (e.g., data for voice call or data communication).

The data encoder 70 encodes the user data and the control information. The modulator 71 modulates the data outputted from the data encoder 70, on the basis of the control information outputted from the control-information generator 68. The transmitter 72 comprises a transmitter amplifier, a filter, a frequency converter, an digital-to-analog converter, and an orthogonal converter, and converts the baseband signal outputted from the modulator 71, into an RF signal.

The broadcast communication controller 73 controls the processing for broadcast communication. Specifically, when the wireless terminal 21 receives a request for broadcast communication from an upper layer such as a communication application, the broadcast communication controller 73 controls the respective portions of the wireless terminal 21 so that the wireless terminal 21 transmits to the master wireless terminal 11 a request for broadcast communication. In addition, the broadcast communication controller 73 controls the respective portions of the wireless terminal 21, on the basis of the broadcast control information transmitted from the master wireless terminal 11, so that the wireless terminal 21 transmits broadcast data to the wireless terminals 11, 22, and 23 in the uplink interval, or receives broadcast data from one of the wireless terminals 11, 22, and 23. At this time, on the basis of the broadcast control information included in the control information transmitted from the master wireless terminal 11, the broadcast communication controller 73 determines whether the wireless terminal 21 is to transmit broadcast data or to receive broadcast data. In addition, when the wireless terminal 21 receives from the master wireless terminal 11 an instruction for transmission of a measurement reference signal, the broadcast communication controller 73 generates broadcast control information containing the measurement reference signal. Further, on the basis of information on the timing of broadcast reception which is outputted from the reception-timing storage 76, the broadcast communication controller 73 controls the respective portions of the wireless terminal 21 so that the wireless terminal 21 receives broadcast data transmitted from one of the wireless terminals 22 and 23 which transmits to the master wireless terminal 11 a request for broadcast communication. Furthermore, the broadcast communication controller 73 controls the respective portions of the wireless terminal 21 so that the wireless terminal 21 performs timing adjustment by the amount of timing adjustment transmitted from the master wireless terminal 11 before broadcast transmission.

The measurement-reference-signal receiver 74 receives a measurement reference signal transmitted from one of the wireless terminals 22 and 23, measures the timing of reception of the measurement reference signal, and outputs information on the measured timing. The reception-timing calculator 75 calculates the timing of broadcast reception on the basis of the information on the measured timing and the amount of timing adjustment transmitted from the master wireless terminal 11. The reception-timing calculator 75 outputs the calculated timing of broadcast reception to the reception-timing storage 76.

The reception-timing storage 76 has the broadcast reception timing table 31. The reception-timing storage 76 stores the timing of broadcast reception (calculated by the reception-timing calculator 75) in correspondence with the one of the wireless terminals 22 and 23 which can perform broadcast transmission. The reception-timing storage 76 outputs to the broadcast communication controller 73 the timing of broadcast reception corresponding to one of the wireless terminals 22 and 23 which transmits to the master wireless terminal 11 a request for broadcast communication and is indicated in the broadcast control information.

In the case where the timing adjustment is performed when the master wireless terminal 11 receives a request for broadcast communication, the master wireless terminal 11 having the construction of FIG. 18 and the wireless terminal 21 having the construction of FIG. 19 operate as explained below.

When the wireless terminal 21 receives a request for broadcast transmission from an upper layer such as a communication application, the broadcast communication controller 73 in the wireless terminal 21 transmits to the master wireless terminal 11 a request for broadcast communication in the uplink interval. When the master wireless terminal 11 receives a request for broadcast communication from one of the wireless terminals 21 to 23, the broadcast communication controller 53 in the master wireless terminal 11 determines a broadcast communication group, and transmits to the one of the wireless terminals 21 to 23 a request for timing adjustment (i.e., an instruction for transmission of a measurement reference signal), where the request for timing adjustment is contained in the control information in the downlink interval.

The one of the wireless terminals 21 to 23 which receives the request for timing adjustment and is designated by the control information to transmit a measurement reference signal transmits a measurement reference signal to the master wireless terminal 11 in an allocated time interval in a designated manner. Hereinafter, it is assumed that the wireless terminal 21 receives the request for timing adjustment.

When the master wireless terminal 11 receives the measurement reference signal from the wireless terminal 21, the measurement-reference-signal receiver 54 in the master wireless terminal 11 measures the timing of reception of the measurement reference signal. Then, the broadcast communication controller 53 calculates the amount of timing adjustment for the wireless terminal 21 on the basis of the measured timing of the reception of the measurement reference signal so that data can be transmitted from the wireless terminal 21 in the uplink interval which is set by the master wireless terminal 11. The amount of timing adjustment is included in the control information, and the master wireless terminal 11 transmits the control information to the wireless terminal 21 in the downlink interval. The broadcast communication controller 53 in the wireless terminal 21 controls the respective portions of the wireless terminal 21 so that the wireless terminal 21 performs timing adjustment by the amount of timing adjustment transmitted from the master wireless terminal 11, and then performs broadcast transmission.

The other wireless terminals 22 and 23 also receive the measurement reference signal transmitted from the wireless terminal 21, and the measurement-reference-signal receiver in each of the wireless terminals 22 and 23 measures the timing of reception of the measurement reference signal. Then, the reception-timing calculator in each of the wireless terminals 22 and 23 calculates the timing of broadcast reception on the basis of the amount of timing adjustment (transmitted from the master wireless terminal 11) and the information on the measured timing (outputted from the measurement-reference-signal receiver), and stores the calculated timing of broadcast reception in the reception-timing storage 76.

When each of the wireless terminals 22 and 23 receives the broadcast control information (indicating an instruction for broadcast communication), the wireless terminal switches the operation mode to the reception mode, sets a timing of reception in correspondence with the wireless terminal 21 (which perform broadcast transmission), and receives broadcast data.

Further, the master wireless terminal 11 can perform broadcast transmission in the downlink interval in a similar manner to the conventional broadcasting or multicast transmission. In addition, the wireless terminals illustrated in FIGS. 18 and 19 can operate to realize any one or combination of the second to sixth embodiments.

The above wireless terminal can reduce power consumption in broadcast transmission.

### 8. Additional Matters

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions and alterations could be made hereto without departing from the spirit and scope of the invention.

What is claimed is:

1. A wireless terminal which performs wireless communication with other wireless terminals by using a first time interval for data transmission and a second time interval for data reception, the wireless terminal comprising:
a receiver which receives from one of said other wireless terminals a request for broadcast communication; and
a controller which generates broadcast control information and controls said wireless terminal so as to transmit the broadcast control information to said other wireless terminals in said first time interval after said receiver receives said request, where the broadcast control information instructs the one of the other wireless terminals to transmit broadcast data in said second time interval, and instructs other ones of the other wireless terminals to receive the broadcast data in the second time interval.

2. The wireless terminal according to claim 1, wherein said controller instructs said one of the other wireless terminals to transmit a measurement reference signal for adjusting a timing of transmission of said broadcast data.

3. The wireless terminal according to claim 2, wherein when said wireless terminal receives said measurement reference signal from said one of the other wireless terminals, said controller calculates an amount of adjustment of timing at which the one of the other wireless terminals transmits data, on the basis of the received measurement reference signal.

4. The wireless terminal according to claim 1, wherein said controller instructs each of said other wireless terminals to periodically transmit a measurement reference signal at intervals which are different for each of the other wireless terminals.

5. The wireless terminal according to claim 2, wherein when said receiver receives said request for broadcast communication from said one of the other wireless terminals, said controller instructs the one of the other wireless terminals to transmit said measurement reference signal.

6. A wireless terminal which performs wireless communication with a master wireless terminal by using a first time interval for data reception and a second time interval for data transmission, where the master wireless terminal performs scheduling, said wireless terminal comprising:
a receiver which receives broadcast control information from said master wireless terminal in said first time interval, where the broadcast control information instructs said wireless terminal to perform broadcast communication in said second time interval; and
a controller which controls said wireless terminal to perform, in said second time interval, one of broadcast transmission of first broadcast data to other wireless terminals and reception of second broadcast data transmitted from one of the other wireless terminals, based on said broadcast control information when said receiver receives the broadcast control information.

7. The wireless terminal according to claim 6, wherein said controller controls said wireless terminal so that said wireless terminal performs said broadcast transmission of said first broadcast data when said broadcast control information contains an instruction which instructs said wireless terminal to perform the broadcast transmission, and receives said second broadcast data when said broadcast control information contains an instruction which instructs said one of the other wireless terminals to perform broadcast transmission.

8. The wireless terminal according to claim 6, further comprising a reference-signal receiver which receives a measurement reference signal which is transmitted from said one of the other wireless terminals to said master wireless terminal for adjusting a timing of transmission of data.

9. The wireless terminal according to claim 8, further comprising a reception-timing calculator which calculates a timing of reception of broadcast data transmitted from each of said other wireless terminals, on the basis of a timing of reception of said measurement reference signal and an amount of adjustment of said timing of transmission of data which is transmitted from said master wireless terminal to said each of said other wireless terminals.

10. The wireless terminal according to claim 9, wherein said reception-timing calculator stores, in a broadcast reception timing table, said timing of reception of broadcast data in correspondence with said each of the other wireless terminals.

11. The wireless terminal according to claim 10, wherein when said each of the other wireless terminals transmits a request for broadcast communication to said master wireless terminal, said controller receives broadcast data transmitted from said each of the other wireless terminals on the basis of the timing of reception stored in said broadcast reception timing table.

12. A communication method performed by a wireless terminal for performing wireless communication with other wireless terminals by using a first time interval for data transmission and a second time interval for data reception, the communication method comprising:
receiving from one of said other wireless terminals a request for broadcast communication;
when said request is received, generating broadcast control information which instructs the one of the other wireless terminals to transmit broadcast data in said second time interval, and instructs other ones of the other wireless terminals to receive the broadcast data in the second time interval; and
transmitting said broadcast control information to said one of the other wireless terminals in said first time interval.

13. A communication method performed by a wireless terminal for performing wireless communication with a master wireless terminal by using a first time interval for data reception and a second time interval for data transmission, where the master wireless terminal performs scheduling, said communication method comprising:
receiving broadcast control information from said master wireless terminal in said first time interval, where the broadcast control information instructs said wireless terminal to perform broadcast communication in said second time interval; and
performing, in said second time interval, one of broadcast transmission of broadcast data to other wireless terminals and reception of broadcast data from one of the other wireless terminals, based on said broadcast control information when said broadcast control information is received.
